(19) United States
(12) Patent Application Publication
(10) Pub. No.: US 2012/0045115 A1
(43) Pub. Date: Feb. 23, 2012

(54) DEFECT INSPECTION DEVICE AND DEFECT INSPECTION METHOD

(76) Inventors: Shuangqi Dong, Tsuchiura (JP); Takashi Hiroi, Yokohama (JP); Takeyuki Yoshida, Hitachinaka (JP)

(21) Appl. No.: 13/266,050

(22) PCT Filed: Apr. 13, 2010
(86) PCT No.: PCT/JP2010/056603

§ 371 Date: Oct. 24, 2011

(30) Foreign Application Priority Data
Apr. 27, 2009 (JP) 2009-108153

(51) Int. Cl. G06K 9/00

(52) U.S. Cl. 382/149

(57) ABSTRACT

Although there is a method for optimizing a threshold for each of regions to be inspected of an acquired detected image, only a single threshold is applied to a single detected image. Thus, when being included in a single image, an insignificant defect is detected at the same sensitivity level as that for a significant defect. The invention proposes a mechanism in which multiple sensitivity regions are set in a single inspection region, and thereby a defect only in a region where a DOI (Defect of interesting) is present in the single inspection region can be detected while being discriminated from the other ones. Specifically, the multiple sensitivity regions are set based on features of an image in the inspection region, and set sensitivities for the respective sensitivity regions are applied to a detected image, a difference image or a determination threshold for a defect determination unit.

### TECHNICAL FIELD

The present invention relates to a device and a method for detecting a defect in an inspection region. The present invention relates to a device and a method for detecting a defect of a fine pattern, a defect due to a foreign matter, and the like in an inspection region by using, for example, electron beams, lamp light, laser light or the like, on the basis of an image (a taken image) acquired from the inspection region.

### BACKGROUND ART

An electron beam inspection device is used for a defect inspection of a wafer, for example. The electron beam inspection device of this type inspects the wafer for a defect roughly in the following steps. Firstly, the electron beam inspection device scans an electron beam in synchronization with the movement of a stage to acquire a secondary electronic image (hereinafter, referred to as a “detected image”) of a circuit pattern formed on the wafer. Next, the electron beam inspection device makes a comparison between the detected image and a reference image and determines that a portion exhibiting a large difference is defective. When a statistically significant method is used for the detected defect to obtain defect information, analysis of distribution of such defects or detailed information of the defects is used to analyze a problem with a wafer manufacturing process.

Meanwhile, in a conventional defect inspection, a defect is determined by applying a certain threshold to a difference image acquired from a detected image and a reference image. In other words, a portion, in the extracted difference image, which exhibits a difference larger than the threshold in intensity between the images is determined to be defective.

However, applying the same threshold to all the regions in an inspected object causes a problem that a lot of false detections (misreports) occur due to an influence of the density or dimensions of a pattern. Hence, a method has been proposed in which the magnitude of a used threshold is optimized according to the density or dimensions of a pattern present in an inspected portion of an inspected object (see Patent Document 1). In addition, a method has been proposed in which an inspected object is divided into multiple regions by using design data, and adjustment parameters are applied to thresholds and gray-scale transformation processing of detected images corresponding to the respective regions (see Patent Document 2).

### PRIOR ART DOCUMENTS

### Patent Documents

Patent Document 1: Japanese Patent Application Publication No. 63-126242

Patent Document 2: Japanese Patent Application Publication No. 11-135583

### SUMMARY OF THE INVENTION

### Problem to be Solved by the Invention

In fact, use of these methods enables optimization of a threshold difference between the inspection regions (detected images). However, a threshold of only one type is still applied to a single inspection region (inspected image). This means that as long as defects are in a single inspection region (inspected image), not only a significant defect but also an insignificant defect is influenced similarly by the set threshold. Consequently, the significant defect and the insignificant defect cannot be discriminated from each other.

### Means for Solving the Problem

Hence, the present invention proposes a mechanism in which multiple sensitivity regions are set in a single inspection region, and a defect only in a region where a DOI (Defect of interesting) is present in the single inspection region can be detected while being discriminated from the other ones. Specifically, multiple sensitivity regions are set in the inspection region based on features of an image in the inspection region, and set sensitivities for the respective sensitivity regions are applied to a detected image, a difference image, and a determination threshold for a defect determination unit.

### EFFECTS OF THE INVENTION

The present invention makes it possible to selectively extract, among defects in a single inspection region, only a significant defect in a partial region designated by an operator. This can considerably reduce time required for a defect inspection.

### BRIEF DESCRIPTION OF THE DRAWINGS

FIG. 1 is a diagram for explaining an example of an overall structure of a semiconductor wafer inspection device according to Embodiment 1.

FIG. 2 is a diagram for explaining a structural layout of a wafer to be used as an inspection target in Embodiment 1.

FIG. 3 is a diagram for explaining a recipe creation step and an inspection step according to Embodiment 1.

FIG. 4 is a diagram showing an example of a GUI screen for a trial inspection according to Embodiment 1.

FIG. 5 is a diagram showing an example of a GUI screen for sensitivity setting according to Embodiment 1.

FIG. 6 is a diagram showing an example of a wiring pattern as an inspection target.

FIG. 7 is a diagram for explaining an overview of inspection processing according to Embodiment 1.

FIG. 8 is a diagram for explaining an example of an operation of generating a sensitivity table according to Embodiment 1.

FIG. 9 is a diagram for explaining an example of an operation of applying a sensitivity table according to Embodiment 1.

FIG. 10 is a diagram for explaining an example of an overall structure of a semiconductor wafer inspection device according to Embodiment 7.

FIG. 11 is a diagram for explaining a step of generating a background feature table.

FIG. 12 is a diagram for explaining an example of an overall structure of a semiconductor wafer inspection device according to Embodiment 8.

FIG. 13 is a diagram showing an example of a GUI screen for sensitivity setting according to Embodiment 9.

FIG. 14 is a diagram for explaining a sensitivity adjustment method according to Embodiment 10.

FIG. 15 is a diagram for explaining a sensitivity adjustment method according to Embodiment 11.

FIG. 16 is a diagram for explaining feature information detection processing according to Embodiment 12.

### MODES FOR CARRYING OUT THE INVENTION

Hereinafter, descriptions are given in turn of embodiments of a defect inspection device and a defect inspection method according to the invention. Note that the drawings used in describing the embodiments are drawn from the standpoint of explaining the embodiments. Thus, the invention is not limited to the drawings to be described later. In addition, the embodiments to be described later can be combined as appropriate.

### (1) Embodiment 1

### (1-1) Device Configuration

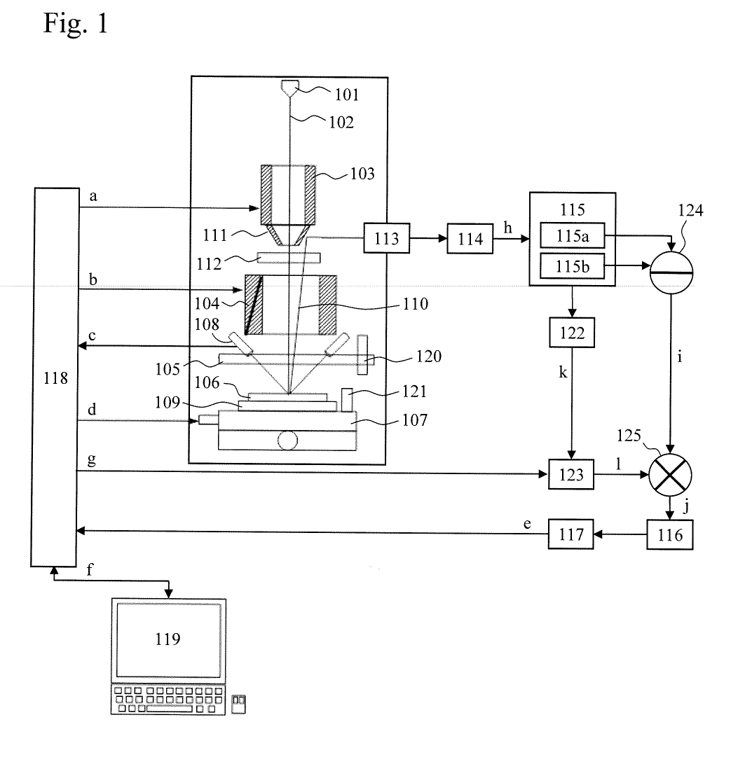

FIG. 1 shows a schematic configuration of a circuit pattern inspection device according to Embodiment 1. Note that FIG. 1 shows a vertical cross-sectional structure and a signal processing system of the circuit pattern inspection device. The circuit pattern inspection device is a device to which a scanning electron microscope is applied and emits electron beams to a semiconductor device substrate such as a wafer. Hence, a chief part thereof is accommodated in a vacuum chamber.

The circuit pattern inspection device emits an electron beam 102 generated from an electron source 101 to a wafer 106 placed on a sample stage 109, detects secondary signals 110 which are generated secondary electrons, reflected electrons, or the like, by using a detector 113, and forms an image. The image is a detected image. Note that the detected image is compared with a reference image, and a pixel region having an intensity difference equal to or larger than a determination threshold is extracted as a defect candidate.

An object lens 104 is arranged on an irradiation path of the electron beam 102 to converge energy of the electron beam 102 on the wafer 106. This object lens 104 narrows a beam diameter. Thus, the diameter of the electron beam 102 on the wafer 106 is made very small.

In order to acquire a detected image in a certain range (inspection region), a deflector 103 deflects the electron beam 102 to scan the wafer 106. At this time, a movement position of the electron beam 102 on the wafer 106 in the scanning and timing of sampling a corresponding one of the secondary signals 110 by the detector 113 are synchronously controlled. Thereby, a two-dimensional image (that is, a detected image) corresponding to an inspection region is acquired or taken.

The wafer 106 has various circuit patterns formed on a surface thereof These circuit patterns are formed of various materials. Thus, the irradiation of the circuit patterns with the electron beam 102 might cause a charge accumulation phenomenon (a charge phenomenon). The charge phenomenon causes lightness of an image to be changed and causes a trajectory of the electron beam 102 made incident to be deflected. Thus, a charge control electrode 105 is arranged in front of the wafer 106 to control an electric field strength.

Incidentally, an image is formed by irradiating a standard sample piece 121 with the electron beam 102 and calibration of coordinates and calibration of a focus point are performed prior to execution of the aforementioned inspection. Meanwhile, since the diameter of the electron beam 102 is very small, the width of scanning by the deflector 103 is much smaller than the wafer 106. In other words, an image (detected image) acquired with the electron beam 102 is very small. Hence, prior to the execution of the inspection, the wafer 106 is firstly placed on an XY stage 107, and a light microscope 120 detects an alignment mark for coordinate calibration formed on the wafer 106. The detection is performed at a comparatively low magnification. Next, the XY stage 107 is moved so that the alignment mark is positioned to be irradiated with the electron beam 102, and thereby the coordinates are calibrated.

In addition, the focal point is calibrated in the following manner. Specifically, the height of the standard sample piece 121 is measured by a Z sensor 108 configured to measure the height of the wafer 106. Next, the height of the alignment mark provided on the wafer 106 is measured. By using a value of the measurement, the excitation strength of the object lens 104 is adjusted so that a focal range of the electron beam 102 narrowed by the object lens 104 includes the alignment mark.

Besides, a deflector 112 is arranged in the circuit pattern detection device so as to detect as many secondary signals 110 generated from the wafer 106 as possible. The deflector 112 is used to deflect the electron beam 102 so that many secondary signals 110 hit a reflector 111. Consequently, many secondary electrons reflected by the reflector 111 are detected by the detector 113.

An overall controller 118 transmits a control signal a to the deflector 103, transmits a strength control signal b to the object lens 104, receives a value c of measurement in a height direction of the wafer 106 from the Z sensor 108, and transmits a control signal d to the XY stage 107.

Each detection signal detected by the detector 113 is converted into a detected image h by a digital image generator 114. The detected image h is stored in an image storage memory 115. In this embodiment, the detected image h is stored in a memory region 115b. Note that a reference image is stored in a memory region 115a. As the reference image, for example, another detected image determined to be normal, a synthesis image generated by synthesizing multiple detected images, an image generated from design data, or the like is used.

A feature detector 122 detects image feature information k from the detected image stored in the memory region 115b. A sensitivity adjuster 123 creates a sensitivity adjustment table l by using the feature information k detected by the feature detector 122 and sensitivity adjustment parameters (sensitivity coefficients) g given by a console 119 through the overall controller 118. The sensitivity adjustment table l includes registered sensitivity values different according to respective multiple regions defined in the inspection region. An example of setting the sensitivity values will be described later. The created sensitivity adjustment table l is given to a sensitivity corrector 125.

The detected image h stored in the memory region 115b and the reference image stored in the memory region 115a are given to a difference image generator 124. The difference image generator 124 generates a difference image i between the detected image h and the reference image by subtracting one from the other. The sensitivity corrector 125 applies the sensitivity adjustment table l to the difference image i and corrects the image in such a manner as to increase the sensitivity in a part of the difference image i and lower the sensitivity in another part thereof The difference image i subjected to the correction (that is, an adjusted difference image j) is stored in a difference image storage memory 116.

A defect determination unit 117 extracts a pixel whose intensity value is larger than zero as a defect candidate among the adjusted difference images j, and sends the overall controller 118 an image signal thereof and corresponding coordinates on the wafer 106, as a defect information signal e. The overall controller 118 and the console 119 are connected with each other to perform two-way communications. For example, a defect image signal based on the defect information signal e is transmitted from the overall controller 118 to the console 119. This displays a defect image on the screen of the console 119. On the other hand, an inspection condition f inputted by the operator is transmitted from the console 119 to the overall controller 118. Based on the inspection condition f, the overall controller 118 performs computing on the control signal a to the deflector 103, the control signal b to the object lens 104, and the control signal d to the XY stage 107.

### (1-2) Inspection Target Example

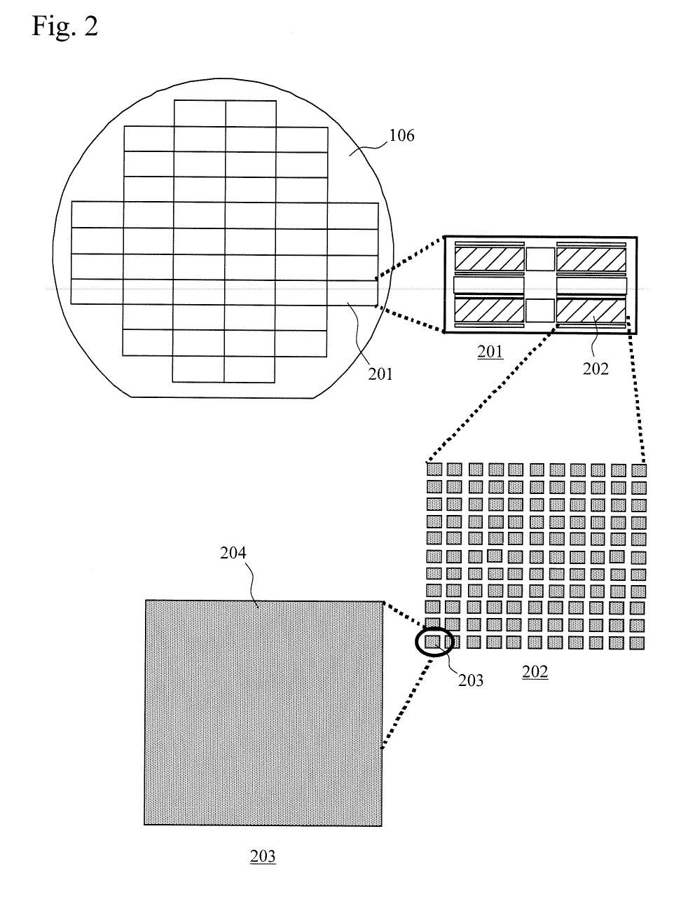

FIG. 2 shows an example of a pattern structure of the wafer 106 which is an example of an inspection target. The wafer 106 has a disc shape having, for example, a diameter of 200 mm to 300 mm and a thickness of 1 mm, approximately. The wafer 106 has circuit patterns formed on a surface thereof, the circuit patterns corresponding to several hundred to several thousand products. Each circuit pattern is formed by a rectangular circuit pattern called a die 201. The die 201 corresponds to a single product. For example, in a case of a general memory device, the die 201 includes four memory mat groups 202 in a pattern layout thereof Further, each memory mat group 202 includes, for example, 100×100 memory mats 203. Each memory mat 203 includes several million memory cells 204 repeated two-dimensionally.

### (1-3) Inspection Recipe Creation Step and Inspection Step

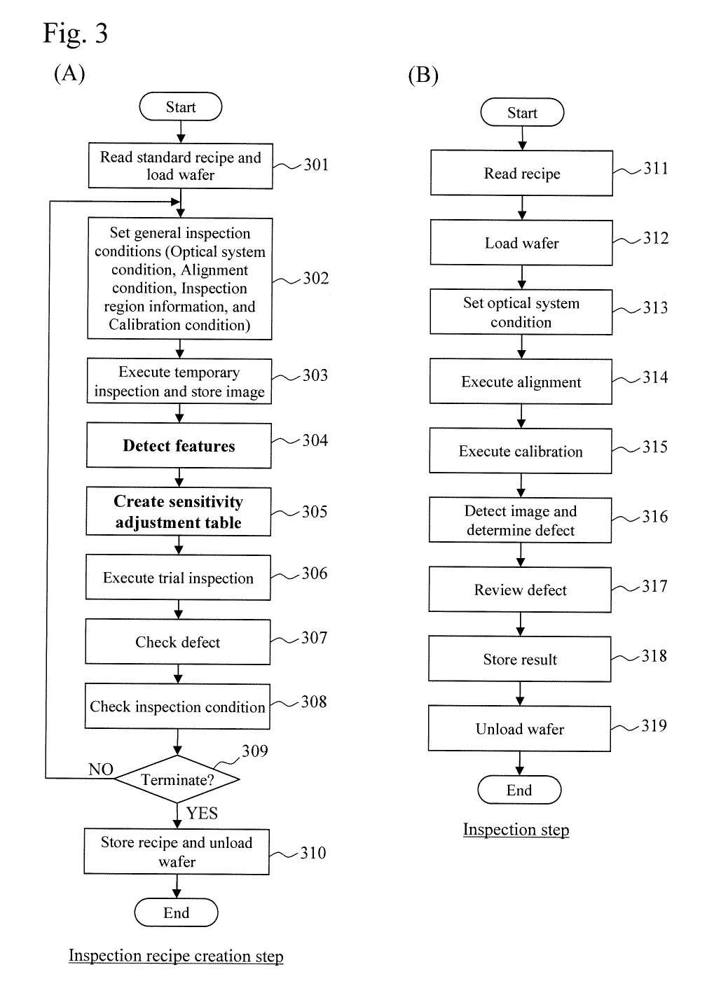

Descriptions are given of an inspection recipe creation step and an inspection step by using FIG. 3. Part (a) of FIG. 3 shows the inspection recipe creation step, and Part (b) of FIG. 3 shows the inspection step. An inspection recipe is created before execution of an inspection.

### (a) Inspection Recipe Creation Step

Descriptions are given of an inspection recipe creation step by using FIG. 3(A). Firstly, the operator instructs the overall controller 118 through the console 119 to read a standard recipe and mount the wafer 106 on the sample stage 109 (Step 301). At this time, the wafer 106 is loaded on the sample stage 109 from an unillustrated cassette by an unillustrated loader.

Next, the operator sets general inspection conditions in the overall controller 118 through the console 119 (Step 302). For example, various conditions are set for, for example, the electron source 101, the deflector 103, the object lens 104, the charge control electrode 105, the reflector 111, the deflector 112, the detector 113, the digital image generator 114, and the like. At this time, an image of the standard sample piece 121 is detected, and set values of regions are corrected to appropriate values according to the detection result. In addition, a pattern layout of the wafer 106 is set. At this time, the operator designates a rectangle for a layout of the memory mat 203 which is a region having the memory cell 204 repeated therein, and sets the memory mat group 202 having the rectangle of the memory mat 203 repeated therein. Moreover, an alignment pattern and coordinates thereof are registered, and thereby an alignment condition is set. Further, information on an inspection region to be inspected is registered. For example, pixel dimensions, the number of additions to be used in image processing, and the like are set. Still further, a calibration condition is set so that the inspection can be made on a constant condition even if amounts of detection light amount vary with the wafer. For example, a coordinate point and an initial gain are set, the coordinate point and the initial gain being used for acquiring an image suitable for light amount calibration.

Upon completion of setting the general inspection conditions, the overall controller 118 executes a temporary inspection, and a detected image is stored in the image storage memory 115 (Step 303). At this time, two detected images are read from the image storage memory 115, and a difference image i therebetween is generated. At the stage of the temporary inspection, the sensitivity adjustment table l including only one sensitivity value registered therein is used. Thus, the difference image i is stored in the difference image storage memory 116.

Thereafter, the feature detector 122 detects the feature information k from the detected image stored in the image storage memory 115 (Step 304).

Next, the operator sets the sensitivity coefficients g for feature amounts through the console 119 (Step 305). The sensitivity coefficients g are given to the sensitivity adjuster 123 through the overall controller 118. The sensitivity adjuster 123 creates the sensitivity adjustment table l by using the sensitivity coefficients g set by the operator. The sensitivity adjustment table l includes sensitivity values for feature amounts detected in the inspection region and sensitivity values for the other regions. The sensitivity adjustment table l is applied to the difference image i by the sensitivity corrector 125. The adjusted difference image j generated by this processing is stored in the difference image storage memory 116.

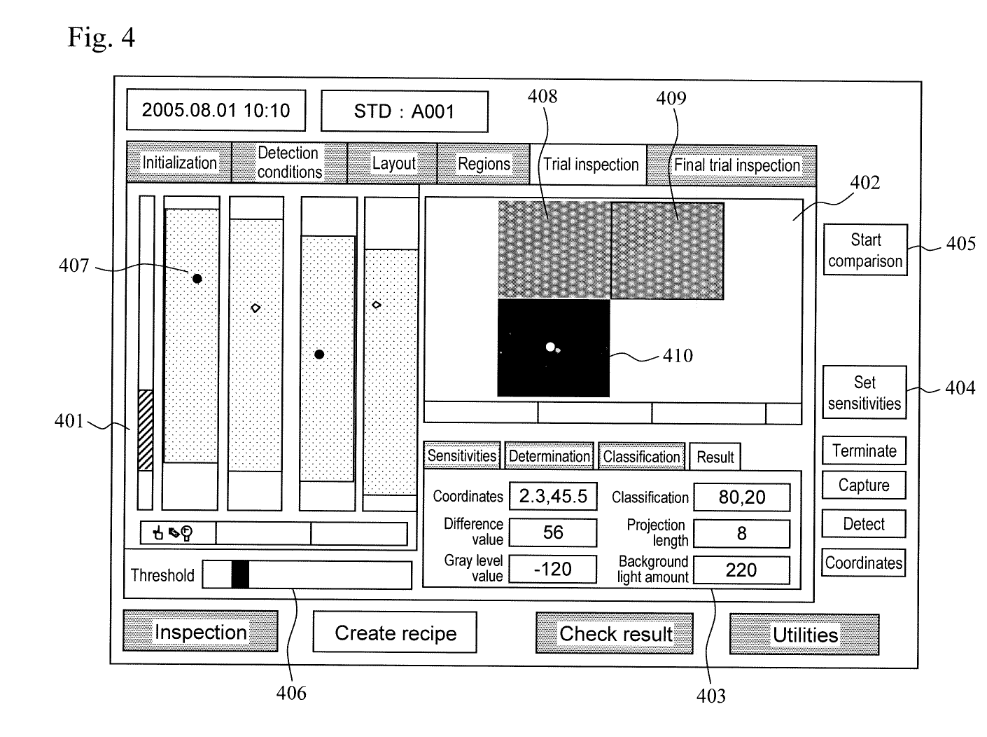

Thereafter, a trial inspection (Step 306), a defect check (Step 307), an inspection condition check (Step 308), and a recipe creation termination determination (Step 309) are executed by using, for example, a GUI (graphical user interface) screen shown in FIG. 4. Note that while the inspection condition is not established, a series of aforementioned steps 302 to 309 is repeatedly executed.

Here, a screen configuration of the GUI screen is briefly explained by taking FIG. 4 as an example. The GUI screen shown in FIG. 4 is a GUI screen used at the time of execution of the trial inspection (Step 306). The GUI screen includes: a region (map display portion) 401 in which stored images are displayed in a map form; a region (image display portion) 402 in which a detected image clicked in the map display portion 401 and an image having a defect 407 in the map display portion 401 are displayed; a region (defect information display portion) 403 in which defect information on the defect 407 displayed in the image display portion 402 is displayed; a sensitivity setting button 404; a comparison start button 405; and a tool bar 406 for adjusting defect display threshold.

In FIG. 4, a display region 408 located in an upper left portion of the image display portion 402 is for displaying a detected image, a display region 409 located in an upper right portion thereof is for displaying a reacquired image, the reference image, a synthesis model image, and the like, and a display region 410 located in a lower left portion thereof is for displaying an image checked for defect.

The trial inspection in Step 306 is performed in the following manner. Firstly, the operator sets an appropriate threshold by operating the tool bar 406 for adjusting defect display threshold, and then clicks the comparison start button 405. This executes a comparison between actual patterns based on images stored in advance. When the trial inspection is executed and when the defect 407 having difference equal to or larger than the threshold is found, the defect 407 appears in the map display portion 401. When the operator clicks on the defect 407, the defect image appears in the image display portion 402 (410), and defect information appears in the defect information display portion 403.

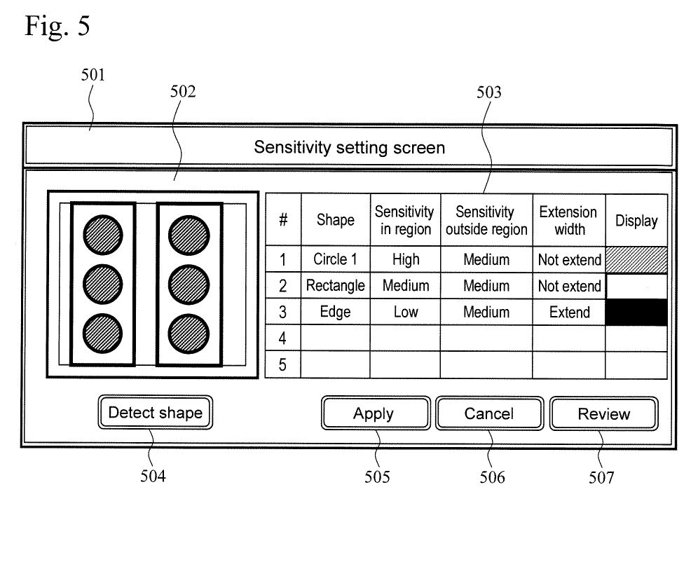

When the operator clicks the sensitivity adjustment button 404, a GUI screen shown in FIG. 5 appears. Sensitivity adjustment through this GUI screen corresponds to the sensitivity adjustment table creation processing (Step 305). A sensitivity adjustment display portion 501 shown in FIG. 5 includes: an image display portion 502 in which the image recorded in advance and the sensitivities for the shapes are displayed; a sensitivity adjustment portion 503 which displays shape information detected from the image displayed in the image display portion 502 and is used for inputting the sensitivity coefficients g; a shape detection button 504 for instructing for execution of processing of detecting feature information from the image displayed in the image display portion 502; an application button 505 for applying numerical values set in the sensitivity adjustment portion 503 to the trial inspection or an actual inspection; a cancellation button 506 for cancelling the numerical values set in the sensitivity adjustment portion 503; and a review button 507 for checking, by using an image, the numerical values set in the sensitivity setting portion 503.

Note that the sensitivity setting (generation of the sensitivity adjustment table l) is performed in the following manner. Firstly, the operator performs an operation of displaying an image stored in advance on the image display portion 502. Next, when the operator clicks the shape detection button 504, a rectangle, a circle, an edge, and the like are detected from the detected image displayed in the image display portion 502, and the various shapes appear in the sensitivity setting portion 503. The operator inputs sensitivity coefficients g for a region inside and a region outside each shape based on the display. To put it differently, the operator sets the multiple sensitivity coefficients g in a single detected image.

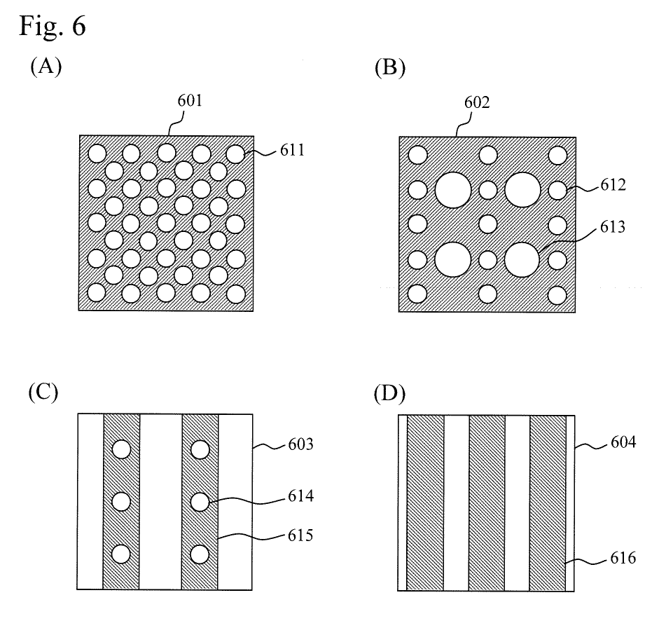

For example, in a case of a semiconductor manufacturing process, various patterns as shown in Parts (A) to (D) of FIG. 6 can be inspected. In this embodiment, multiple sensitivities optimum for the respective patterns can be set in the single detected image. Incidentally, Parts (A) to (C) of FIG. 6 show examples of hole patterns 601, 602, and 603 made in a drilling step. For example, the hole pattern 601 is a pattern formed by circles 611 having the same diameter. For example, the hole pattern 602 is a pattern formed by circles 612 and circles 613 having different diameters. The hole pattern 603 is a pattern formed by circles 614 having the same diameter and two wiring patterns 615 having the same line width. Part (D) of FIG. 6 shows an example of a wiring pattern 604. The wiring pattern 604 is a pattern formed by three wirings 616 each having a certain line width.

Generally, an operator is interested in defect detection in a particular pattern portion in patterns generated in a wafer. Thus, this sensitivity setting enables the sensitivity of a portion of operator's interest to be set higher than the surrounding portions. Note that FIG. 5 shows a case where each sensitivity coefficient g is selected from “high,” “middle,” and “low.” However, the sensitivity coefficient g can be inputted as a numeric value. In addition, the case of FIG. 5 allows an extended width to be set as “extend” or “not extend.” The extended width is used to provide whether or not to extend the setting range, applied to the line width, of the sensitivity coefficient g for a detected line. For example, the extended width is used to increase the sensitivity for a defect on a line. In the case of FIG. 5, the selection is made only on whether or not to extend the line width, but a configuration can be employed in which a selection is made from multiple degrees. Moreover, the sensitivity setting portion 503 enables selection of a display of a detected shape in the image display portion 502. This is a function for facilitating checking of a shape detected by a click operation on the shape detection button 504 and for preventing unintended sensitivity setting.

Next, when the operator clicks the review button 507, the shapes and the sensitivities therefor set in the image display portion 503 appear in the image display portion 502. Lastly, when the operator clicks the application button 505, a feature table is generated in the sensitivity adjuster 123 based on the sensitivity coefficients set in the sensitivity setting portion 503. This completes the sensitivity setting using the sensitivity setting screen 501, and the individual sensitivity coefficients g set in the sensitivity setting portion 503 are ready for application to an inspection. Note that the operator can revoke the numerical values set in the sensitivity setting portion 503 by clicking the cancellation button 506. In addition, the sensitivity setting screen 501 can be forcedly closed by merely clicking the cancellation button 506.

After the setting of the sensitivities (generation of the sensitivity adjustment table l), the aforementioned GUI screen shown in FIG. 4 appears, and the trial inspection is executed. As described above, the trial inspection is started by the operation of clicking the comparison start button 405. This click operation triggers reading the sensitivity coefficients g set on the sensitivity setting screen 501 from the sensitivity adjustment table l, and execution of the comparison between the actual patterns stored in advance. Thereafter, the operator checks for the defect detected through the image display portion 402 (Step 307). If there is no problem (an affirmative result in Step 309), the recipe creation is terminated. After the termination of the recipe creation, the wafer is unloaded, and the features, the sensitivity coefficients g, and the like of the shapes set in the sensitivity adjuster 123 are stored in the recipe (Step 310). If there is a problem with the detected defect (a negative result in Step 309), the processing returns to the general inspection condition setting, and then executes the aforementioned series of processing steps.

### (b) Inspection Step

The description is given of an actual inspection step on the basis of Part (B) of FIG. 3. The operator designates a wafer to be inspected and a recipe therefor to start an inspection operation (Step 311). Then, the designated wafer is loaded (Step 312), and optical conditions for units of an electronic optical system and the like are set (Step 313). Subsequently, an alignment (Step 314) and a calibration (Step 315) are executed. With the aforementioned processing, preparation work for an inspection is completed.

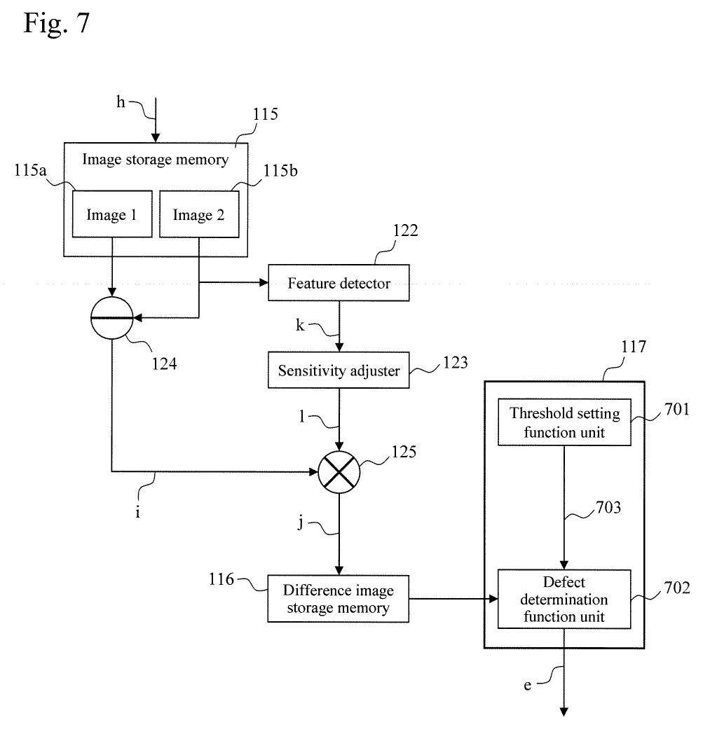

Thereafter, an image detection and a defect determination are executed (Step 316). Firstly, an image (detected image) is acquired from a set region. The detected image has been stored in the image storage memory 115 as shown in FIG. 7. The feature detector 122 reads the detected image from the memory region 115b and extracts feature information k (shape features) from the detected image. The extracted feature information k is given to the sensitivity adjuster 123.

Next, the sensitivity adjuster 123 collates the feature information k with the feature table of the recipe. At this time, the sensitivity adjuster 123 creates a sensitivity adjustment table l unique to the detected image so that the sensitivity coefficient in the recipe is applied to a matching region. However, if the detected feature information k is not present in the recipe, the sensitivity adjuster 123 writes the sensitivity coefficient individually set by the operator to the sensitivity adjustment table l.

Thereafter, the difference image generator 124 creates a difference image i between the detected image (115b) and a reference image (115a). The created difference image i is given to the sensitivity corrector 125. The sensitivity corrector 125 applies the sensitivity adjustment table l to the difference image i, and outputs an adjusted difference image j to which the sensitivities set for feature portions in the detected image is applied. This adjusted difference image j is stored in the difference image storage memory 116.

This adjusted image j is read by the defect determination unit 117. The defect determination unit 117 includes a threshold setting function unit 701 and a defect determination function unit 702. The threshold setting function unit 701 is used by the operator to set threshold information. A threshold thus set is used as a threshold table 703. The defect determination function unit 702 applies the threshold table 703 to the adjusted difference image j read from the difference image storage memory 116. In sum, the defect determination function unit 702 compares the intensities of the adjusted difference image j with the threshold in the threshold table 703 and outputs a region having an intensity larger than the threshold therefor as a defect information signal e.

Upon determination of the defect as described above, a review of the defect by the operator is executed (Step 317). The operator checks a defect type based on the detected image acquired at the inspection and displayed in the image display portion 402, a reacquired image reacquired when the stage is moved to the defect coordinates, a synthesis model image, an image checked for defect, and the like.

Upon completion of the defect review, necessities for wafer quality determination based on defect distribution on a defect type basis and for additional analysis are determined After these results are stored in the overall controller 118 (Step 318), the wafer is unloaded, and the inspection is terminated (Step 319).

### (1-4) Detailed Operations of Detecting Features and Adjusting Sensitivities

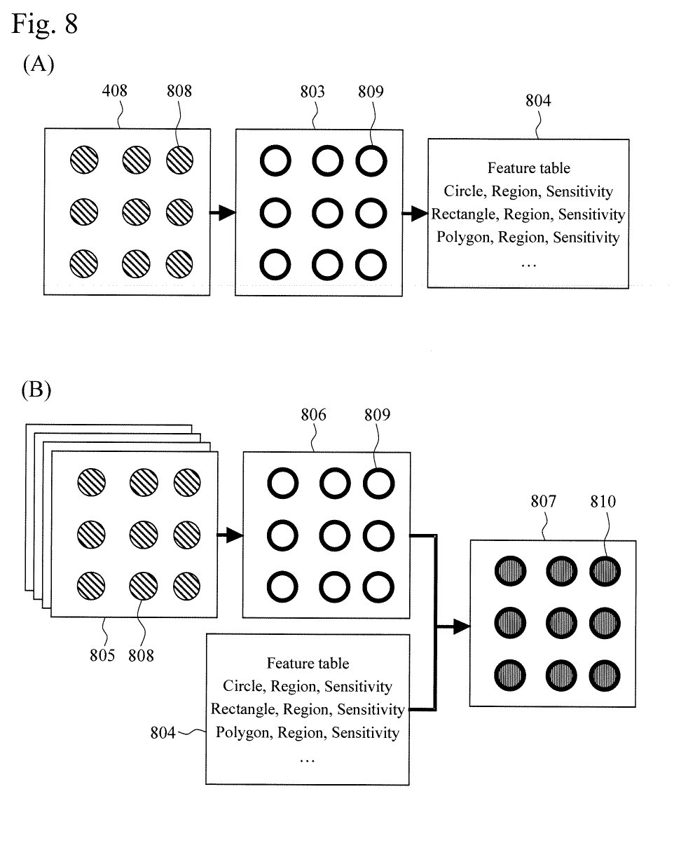

Subsequently, a description is given of details of aforementioned operations performed by the feature detector 122 and the sensitivity adjuster 123. Firstly, a flow of processing operations in the trial inspection is described by using Part (A) of FIG. 8. Note that a circle pattern 808 is formed in the detected image 408. In the trial inspection, the feature detector 122 executes noise elimination processing and edge detection processing on the image 408. As the result, an edge image 803 is generated. Based on the edge detection, an edge portion 809 of the pattern 808 is extracted. Thereafter, the feature detector 122 applies a Hough transform and a circular Hough transform to the edge image 803 to detect feature information on a circle, a line, and the like from the edge image 803.

The sensitivity adjuster 123 registers the detected feature information in a feature table 804. Subsequently, the operator checks the features registered in the feature table 804 on the screen. The operator sets a high sensitivity coefficient g for a portion having feature information recognized as a DOI defect by the operator, while setting a low sensitivity coefficient g for the other portions. In sum, the feature table 804 including sets of information is added to the recipe, the sets of information each having (i) feature information, (ii) a region corresponding to the feature information, and (iii) a sensitivity coefficient g corresponding to the feature information.

Next, a flow of processing operations in the actual inspection is described by using Part (B) of FIG. 8. Also in the actual inspection, the feature detector 122 executes the noise elimination processing and the edge detection processing on a detected image 805. Thereby, an edge image 806 is acquired. Thereafter, a Hough transform and a circular Hough transform are applied to the edge image 806 to detect circle pattern regions and line pattern regions included in the edge image 806. The processing performed so far are the same as those in the trial inspection.

The sensitivity adjuster 123 executes processing of collating detected feature information with the feature information in the feature table 804. If there is a match in the feature information, the sensitivity adjuster 123 writes a corresponding one of the sensitivity coefficients g set in the feature table 804 in an adjustment region 810 in a sensitivity adjustment table 807. If no matching feature information is present, the sensitivity adjuster 123 writes a default sensitivity coefficient g set by the operator in the adjustment region 810 in the sensitivity adjustment table 807.

### (1-5) Effects of Sensitivity Adjustment to Partial Regions

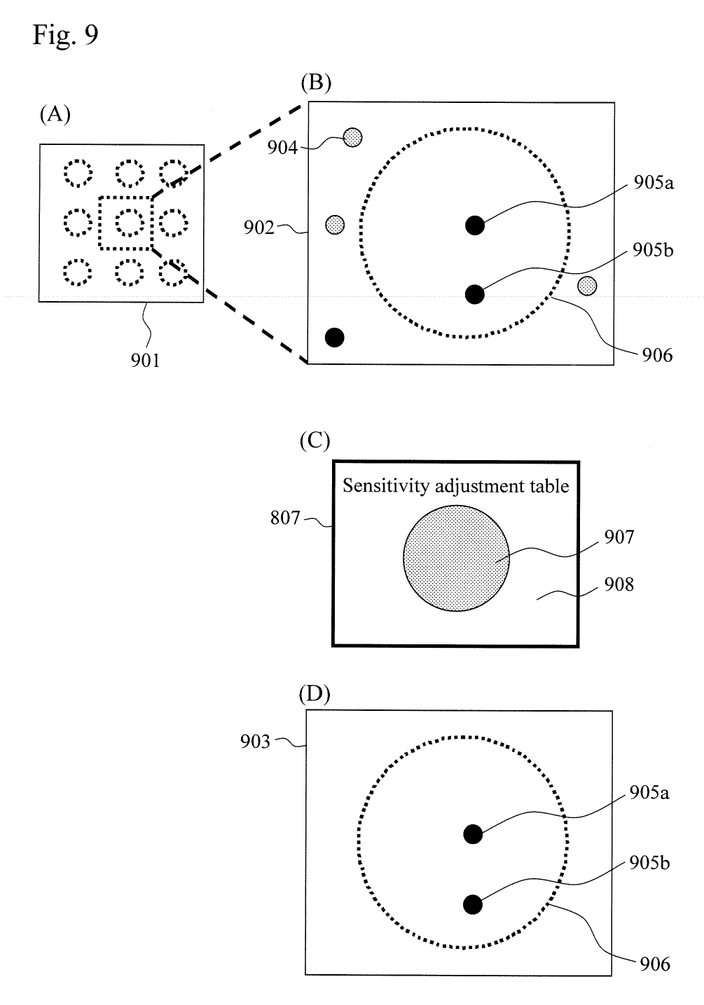

By using FIG. 9, a description is given of effects due to the capability of setting the multiple sensitivities on the single detection screen in this embodiment. Note that Part (A) of FIG. 9 shows a difference image 901 created by a detected image and a reference image. Part (B) of FIG. 9 shows an enlarged image 902 in which a part of the difference image 901 is enlarged. Part (C) of FIG. 9 shows the sensitivity adjustment table 807 generated by collating detected feature information with feature information in a feature table. Part (D) of FIG. 9 shows an enlarged image 903 of an adjusted difference image j obtained after application of a sensitivity adjustment table 907 to the difference image 901.

In the actual inspection, the sensitivity adjustment table 807 is applied to the difference image 901 created from the inspected image and the reference image, as described above. As shown in Part (B) of FIG. 9 in an enlarged manner, a defect 905a and a defect 905b which have different intensities are present in a circular region 906 in the difference image 901, and multiple defects 904 having different intensities are present outside the circular region 906.

In a case of a conventional method, all the defects are not discriminated from each other, and a single sensitivity is set for one entire detected image, and a comparison with a single threshold is made, whereby a defect is determined

However, in this embodiment, by using the sensitivity adjustment table 807, a region 907 having a high sensitivity value is written to the circular region 906, and a region 908 having a low sensitivity value is written to an outside region thereof, as shown in Part (C) of FIG. 9. Thus, when the sensitivity adjustment table 807 is applied to the difference image 901, an adjusted difference image 903 including only the defects 905a and 905b in the circular region 906 can be obtained, as shown in Part (D) of FIG. 9 which is an enlarged view of the difference image 901. That is, the defects 906 present in the region having a low sensitivity value 908 set therefor are eliminated from the adjusted difference image 903.

As described above, application of a technique according to the embodiment makes it possible to show the operator only the defects 905a and 905b present in a DOI shape region. In other words, it is possible to omit work in which the operator himself/herself differentiates a significant defect, from the other defects, included in defects detected from an inspection region based on the same sensitivity. Consequently, the operator can review only defects present in the DOI region on the screen at the time of defect review. Thus, the efficiency of a review by the operator can be enhanced. Moreover, since a region can be designated by using feature information in this embodiment, the operator does not have to accurately calculate the location of the DOI region, and can easily designate a region to be adjusted. As the result, it is possible to prevent an occurrence of a misreport without lowering the defect capture efficiency of the entire wafer or the entire die. Furthermore, since the sensitivity only for a particular region can be increased, a high-sensitivity inspection can substantially be achieved.

Besides, this embodiment employs a method in which the sensitivities are set through the designation of the feature amounts included in an image. Thus, even at a stage of design data in which no detected image is present, the sensitivity adjustment regions can be set. Consequently, time to acquire a detected image for setting the sensitivity adjustment regions can be saved. Also in this point, the technique according to the embodiment is effective to enhance the production efficiency.

Still further, in this embodiment, multiple sensitivities can be set in a single detected image. Thus, the sensitivities to detected defects can be applied respectively. As the result, the ratio of misreports can be made small enough, and thus the work efficiency in an inspection process can be enhanced.

### (2) Embodiment 2

Next, a description is given of a circuit pattern inspection device according to Embodiment 2. Note that a basic device configuration of the circuit pattern inspection device according to Embodiment 2 and basic processing steps thereof are the same as those in Embodiment 1. Hereinafter, only a difference from Embodiment 1 will be described.

In Embodiment 1 described above, a Hough transform is applied in the feature information detection processing performed by the feature detector 122. However, the feature information can be detected by another method. For example, template matching is applicable thereto.

In this embodiment, the feature detector 122 executes noise elimination on the detected image 805, and executes processing of matching with a template image prepared in advance on the image subjected to the noise elimination. Such a processing method can also detect necessary feature information in the detected image 805. Note that since the template matching is a known technique, a detailed description thereof is omitted. In addition, it is possible to apply a method in which the operator selects a used template from multiple templates in advance.

In Embodiment 2, the following effects can be expected in addition to the effects of Embodiment 1. In sum, the operator can dynamically designate a region of his/her interest through a template selection operation. Thus, the review efficiency can be enhanced over that in Embodiment 1. Further, the template selection by the operator can be executed intuitively. Consequently, stress on the operator can be reduced.

### (3) Embodiment 3

Next, a description is given of a circuit pattern inspection device according to Embodiment 3. Note that the circuit pattern inspection device according to Embodiment 3 also has a basic device configuration and basic processing steps as the same as those in Embodiment 1. Hereinafter, only a difference from Embodiment 1 will be described.

In Embodiment 1 described above, the description has been given of the case where the feature detector 122 has feature information of the detected image, which is a circle, a rectangle, and a line. However, it goes without saying that the feature information included in the detected image 408 is not limited thereto. For example, a case where the feature information is a polygon is conceivable. A polygon includes a combination of all or some of a circle, a rectangle, and a line. The polygon also includes a combination of multiple same-type shapes.

The feature detector 122 in this embodiment can be implemented by adding a function of detecting or determining a polygon to the feature detector 122 in Embodiment 1.

Compared with Embodiment 1, a range of a figure detectable as feature information can be extended by using Embodiment 3.

### (4) Embodiment 4

Next, a description is given of a circuit pattern inspection device according to Embodiment 4. Note that the circuit pattern inspection device according to Embodiment 4 also has a basic device configuration and basic processing steps as the same as those in Embodiment 1. Hereinafter, only a difference from Embodiment 1 will be described.

In Embodiment 1 described above, the description has been given of the case where shapes registered in the feature table by the sensitivity adjuster 123 are a circle, a line, and a rectangle. However, it goes without saying that the shapes registered in the feature table are not limited thereto. For example, a polygon may be registered in the feature table. The polygon in this embodiment also includes a combination of all or some of the circle, the rectangle, and the line. The polygon also includes a combination of multiple same-type shapes.

The sensitivity adjuster 123 in this embodiment can be implemented by adding a function of detecting or determining a polygon to the sensitivity adjuster 123 in Embodiment 1.

Compared with Embodiment 1, a range of sensitivity adjustment can be extended by using Embodiment 4.

### (5) Embodiment 5

Next, a description is given of a circuit pattern inspection device according to Embodiment 5. Note that the circuit pattern inspection device according to Embodiment 5 also has a basic device configuration and basic processing steps as the same as those in Embodiment 1. Hereinafter, only a difference from Embodiment 1 will be described.

In Embodiment 1 described above, the description has been given of the case where the feature detector 122 detects feature information from the detected image 408. However, the feature information can be detected from an image other than the detected image 408. For example, an image to be used for defect determination, a synthesis image created from multiple images, and an image generated from design data can be used for detecting the feature information.

### (6) Embodiment 6

Next, a description is given of a circuit pattern inspection device according to Embodiment 6. Note that the circuit pattern inspection device according to Embodiment 6 also has a basic device configuration and basic processing steps as the same as those in Embodiment 1. Hereinafter, only a difference from Embodiment 1 will be described.

In Embodiment 1 described above, the description has been given of the case where the sensitivity adjuster 123 sets sensitivities for shapes detected from the detected image. However, the sensitivity setting is not limited to this step. For example, by using a feature information database prepared in advance, the sensitivities for the feature information may be set before the detected image is acquired or before the feature information is acquired from the detected image.

### (7) Embodiment 7

### (7-1) Device Configuration

Next, a description is given of a circuit pattern inspection device according to Embodiment 7. Note that the circuit pattern inspection device according to Embodiment 6 also has a basic device configuration and basic processing steps as the same as those in Embodiment 1 Hereinafter, only a difference from Embodiment 1 will be described.

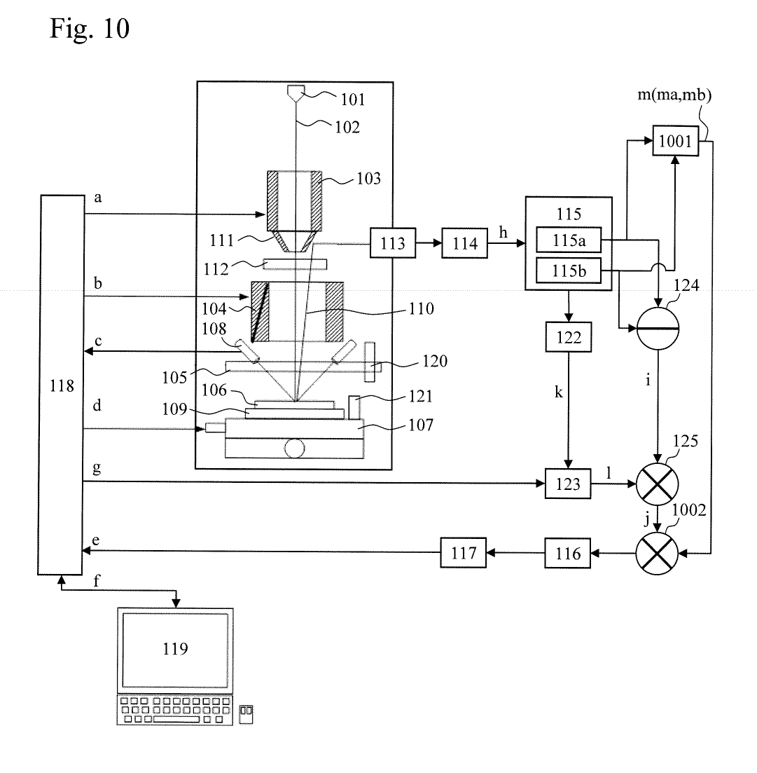

FIG. 10 shows a schematic configuration of a circuit pattern inspection device according to this embodiment. Note that portions in FIG. 10 corresponding to those in FIG. 1 are illustrated while being assigned the same reference signs. Embodiment 7 is different from Embodiment 1 in that a background feature analyzer 1001 and a background feature adding unit 1002 are added to the device configuration in Embodiment 1.

The background feature analyzer 1001 executes processing of analyzing a region having a white back ground and a region having a black background and of recording an analysis result in a background feature table m. The analysis is made by comparing a detected image stored in the image storage memory 115 and a reference image (such as a synthesis image obtained by synthesizing multiple detected images or an image generated from design data).

In this specification, the white background and the black background are used in the following sense. An image 1 and an image 2 are herein present. The image 1 is the detected image, while the image 2 is the reference image. An image obtained by subtracting an intensity value of the reference image from an intensity value of the detected image is referred to as a difference image (=the image 1−the image 2). In this specification, in the difference image, a region in which an intensity value larger than 0 (zero) is present is referred to as the black background, while a region in which an intensity value equal to or smaller than 0 (zero) is present is referred to as the white background.

The background feature analyzer 1001 in this embodiment registers a region detected as the white background in a white background sensitivity adjustment table ma, and registers a region detected as the black background in a black background sensitivity adjustment table mb. Note that the background feature table m is additionally formed in a partial region of the sensitivity adjustment table l created by the sensitivity adjuster 123. However, the background feature table m may be created as a table independent from the sensitivity adjustment table l.

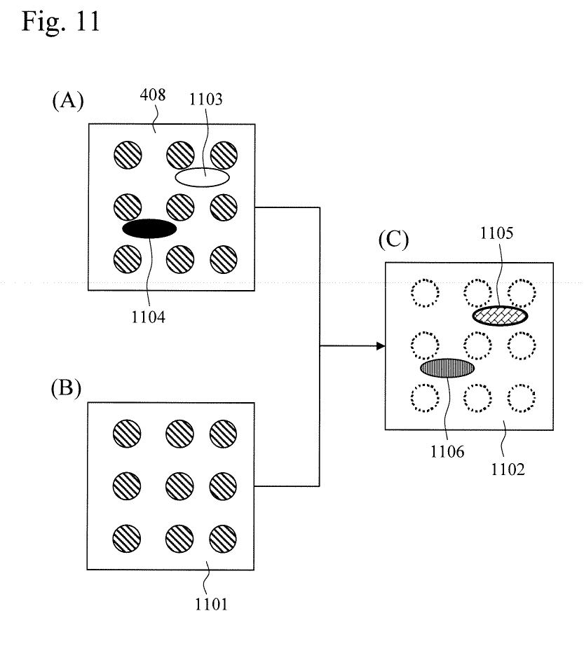

The details of the background feature table m created by the background feature analyzer 1001 are described by using FIG. 11. Part (A) of FIG. 11 shows a detected image 408 stored in the image storage memory 115. Part (B) of FIG. 11 shows a reference image 1101 for comparison with the detected image 408. Part (C) of FIG. 11 shows a background feature table 1102. In Part (A) of FIG. 11, in the detected image 408, a region 1103 having a higher intensity than the reference image 1101 is the black background, while a region 1104 having a lower intensity than the reference image 1101 is the white background. Thus, as shown in Part (C) of FIG. 11, a region 1106 is registered in the white background sensitivity adjustment table ma, and a region 1105 is registered in the background feature table mb.

The background feature adding unit 1002 applies the background feature table m to an adjusted difference image j outputted from the sensitivity corrector 125 and adjusts the sensitivities according to whether the detected defect image belongs to the white background or the black background. To put it differently, in this embodiment, background information is used for readjusting the sensitivities of an adjusted difference image j. Note that the sensitivities to be applied to the white background and the sensitivities to the black background are set by the sensitivity adjuster 123, for example. An adjusted difference image j subjected to the readjustment is stored in the difference image storage memory 116.

### (7-2) Characteristics of Processing Operation

Next, a description is given of a processing operation portion particular to this embodiment. Thus, the description is mainly given of operations of the background feature analyzer 1001 and the background feature adding unit 1002. The same processing as that in Embodiment 1 is executed in the other circuit portions, as a matter of course.

The background feature analyzer 1001 calls the detected image 408 and the reference image 1101 from the image storage memory 115 to acquire intensity differences on a pixel basis. Here, an intensity of a certain pixel in the detected image 408 is A(x, y), and an intensity of a certain pixel in the reference image 1101 is B(x, y). At this time, if the intensity difference (A−B) of the certain pixel in the detected image 408 from that in the reference image 1101 is a value equal to or larger than zero, it is determined that the pixel has the black background. On the other hand, the intensity difference (A−B) is a value smaller than zero, it is determined that the pixel has the white background. The background feature analyzer 1001 calculates the intensity difference for all the pixels to create the background feature adding table 1102. In the case of Part (C) of FIG. 11, the region 1105 having the black background and the region 1106 having the white background which are outside circle patterns are present.

Information on the background feature table m is applied to the adjusted difference image j by the background feature adding unit 1002. Note that the sensitivity of the outside of the circle patterns is set high in this Embodiment 7, contrary to Embodiment 1. In other words, in the adjusted difference image j outputted from the sensitivity corrector 125, sensitivities for the region 1103 and the 1104 are both set high.

Thus, the background feature adding unit 1002 corrects the sensitivities according to whether each of the region 1103 and the region 1104 is the white background or the black background. For example, the background feature adding unit 1002 operates in a manner that the sensitivities for the white background and the black background are collectively increased or lowered, or in a manner that the sensitivity for one is increased and the sensitivity for the other is lowered.

Consequently, the operator can find both or only one of the region 1103 and the region 1104 as a DOI defect in the detected image on the basis of the sensitivities set according to the background type. In other words, the operator can not only execute the defect review easily but also execute a defect analysis and classification of the DOI region simultaneously.

Note that differently in the description above, the background feature adding unit 1002 can be used as a function unit configured to give the background information as added information to the adjusted difference image j. In this case, the background information can be used at the stage of the determination processing performed by the defect determination unit 117. For example, the background information can be used for adjusting a determination threshold. In addition, a method can be employed in which the background information is not used for the processing by the defect determination unit 117 but is outputted to the overall controller 118 as added information as it is. In this case, the background information can be used for various post-processing to be executed by the overall controller 118.

### (8) Embodiment 8

Next, a description is given of a circuit pattern inspection device according to Embodiment 8. Note that a basic device configuration of the circuit pattern inspection device according to Embodiment 8 and basic processing steps thereof are similar to those in Embodiment 7 (or Embodiment 1). To put it differently, Embodiment 8 corresponds to a modification of Embodiment 7.

In Embodiment 7 described above, the description has been given of the case where the background information is applied to the adjusted difference image j. In this embodiment in contrast, the background information is applied to the defect information signal e outputted from the defect determination unit 117.

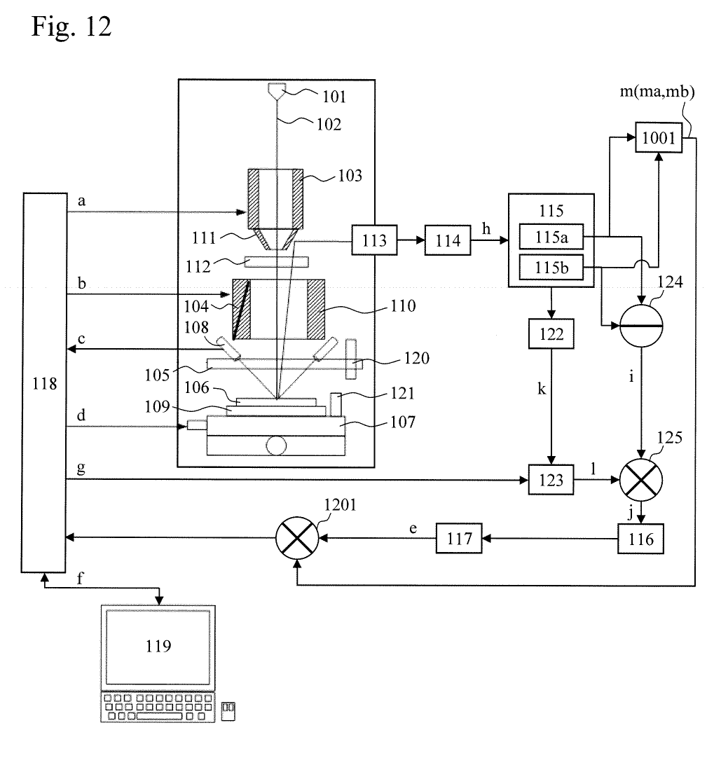

FIG. 12 shows a schematic configuration of the circuit pattern inspection device according to Embodiment 8. Note that portions in FIG. 12 corresponding to those in FIG. 10 are illustrated while being denoted by the same reference signs. In Embodiment 8, a background feature adding unit 1201 is used instead of the background feature adding unit 1002 in Embodiment 7. The background feature adding unit 1201 is arranged between the defect determination unit 117 and the overall controller 118. Thus, processing operations up to the operation of the defect determination unit 117 in this Embodiment 8 are the same as those in Embodiment 1.

In this embodiment, the background feature adding unit 1201 can function as a function unit, for example, configured to add the background information as added information to the defect information signal e outputted from the defect determination unit 117. In this case, the overall controller 118 can determine the ratio of the white background to the black background and tendencies of defects according to each type later.

In addition, in this embodiment, the background feature adding unit 1201 can function as a function unit configured to correct a sensitivity for each defect included in the corresponding defect information signal e outputted from the defect determination unit 117. In this case, only a DOI of the operator's interest can be stored in the overall controller 118.

### (9) Embodiment 9

Next, a description is given of a circuit pattern inspection device according to Embodiment 9. Note that a basic device configuration of the circuit pattern inspection device according to Embodiment 9 and basic processing steps thereof are the same as those in Embodiment 1. Hereinafter, only a difference from Embodiment 1 will be described.

In Embodiment 1 described above, the description has been given of the case where the feature detector 122 detects the feature information while focusing on shapes in the detected image 408. However, the feature information can be detected by using an intensity or a color.

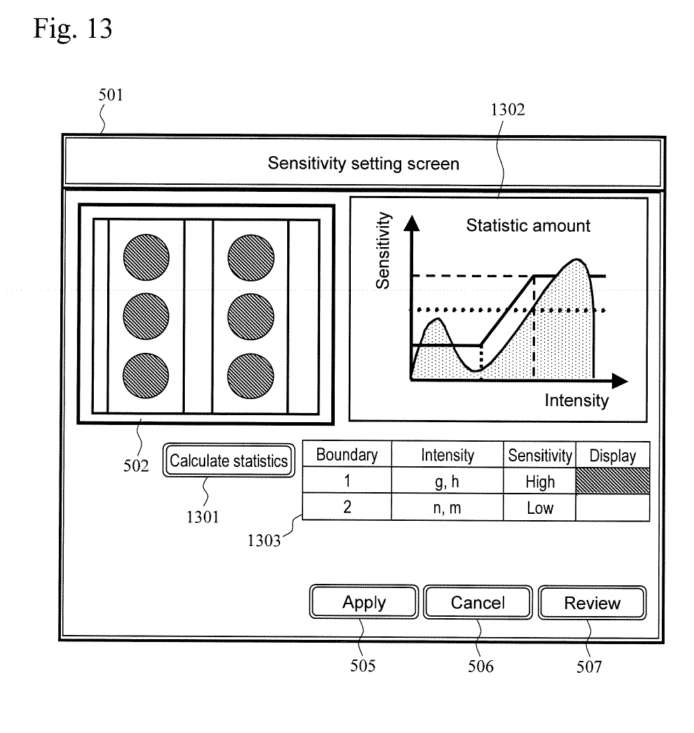

FIG. 13 shows a display example of the sensitivity setting screen 501 according to Embodiment 9. Note that portions in FIG. 13 corresponding to those in FIG. 5 are illustrated while being denoted by the same reference signs. The sensitivity adjustment display portion 501 shown in FIG. 13 includes: the image display portion 502 configured to display sensitivities for images and shapes which are recorded in advance; a statistic calculation button 1301 for instructing for execution of processing of statistically calculating intensity distribution of an image displayed in the image display portion 502; a statistic amount display portion 1302 configured to display the statistic intensity distribution calculated from the image displayed in the image display portion 502; a sensitivity setting portion 1303 for setting a range of the statistic amount and sensitivities to be applied to the range; an application button 505 for applying numerical values set in a sensitivity adjustment portion 1303 to an trial inspection or an actual inspection; a cancellation button 506 for cancelling the numerical values set in the sensitivity adjustment portion 1303; and a review button 507 for checking, by using an image, the numerical values set in the sensitivity setting portion 1303.

Hereinafter, processing operations particular to this embodiment will be described. The sensitivity adjustment display portion 501 shown in FIG. 13 is displayed by clicking the sensitivity setting button 404 in the trial inspection of Part (A) of FIG. 3. Next, by using the image display portion 502, the operator checks a detected image stored in advance. Subsequently, the operator operates the statistic calculation button 1301 by clicking thereon to obtain statistic values. The overall controller 118 detects this clicking operation to calculate the statistic values. A calculated statistic amount is displayed in the statistic amount display portion 1302 in a graph, a character string or a three-dimensional form or another form. FIG. 13 shows the intensity distribution with a curved line.

The operator checks the values of the statistic amount and sets intensities and sensitivities to be used as boundaries. In the case of FIG. 13, the operator sets a sensitivity for a high intensity (a range from an intensity g to an intensity h) to be high and sets a sensitivity for a low intensity (a range from an intensity n to an intensity m) to be low.

Thereafter, the operator clicks the review button 507 to check the detected image subjected to sensitivity correction which is displayed in the image display portion 502. When being satisfied with the detected image subjected to the sensitivity correction, the operator clicks the application button 505. On the other hand, if the operator determines that readjustment is needed, the operator sets values in the sensitivity setting portion 1303 again, clicks the review button 507, and thereby checks a sensitivity image. Note that when wishing to stop the sensitivity adjustment, the operator clicks the cancellation button 506.

As described above, when the application button 505 is clicked, setting information therefor is reflected on a corresponding inspection condition. Thereafter, the operator checks the result of the trial inspection executed according to the reset sensitivity conditions. If there is no problem, the operator terminates the creation of a recipe. Upon termination of the creation of the recipe, the wafer is unloaded. In addition, the intensities set by the sensitivity adjuster 123 and information on the sensitivity coefficients are stored in the recipe.

Next, in the actual inspection, a wafer to be inspected and recipe information thereon are designated to start an inspection operation. As shown in Part (B) of FIG. 3, after the start of the inspection, the designated wafer is loaded, and optical conditions for units of the electronic optical system and the like are set. Subsequently, an alignment and a calibration are executed. Upon completion of the preparation work, an image in a set region is acquired, and intensity distribution is statistically calculated from the detected image.

Thereafter, the sensitivity adjuster 123 collates intensity values of the detected image with regions of the intensity values set in the recipe, and registers a sensitivity coefficient g for a region having a matching intensity value range. That is, a sensitivity adjustment table l is generated. In the meantime, a difference image i is created from the detected image and a reference image which are stored in the image storage memory 115. The sensitivity corrector 125 applies the sensitivity adjustment table l to the difference image i, and stores the difference image i as an adjusted difference image j in the difference image storage memory 116. Thereafter, the defect determination unit 117 executes a defect determination on the adjusted difference image j stored in the difference image storage memory 116.

After the defect determination, a defect review is executed. In the defect review, the operator executes checking of a defect type on a detected image 408 acquired in the inspection, a reacquired image reacquired when the stage is moved to correspond to the defect coordinates, a synthesis image generated by synthesizing multiple detected images, an image checked for defect, and the like. Upon completion of the defect review, necessities for wafer quality determination based on defect distribution on a defect type basis and for additional analysis are determined These results are stored in the overall controller 118, the wafer is unloaded and the inspection is terminated.

As in this embodiment, even if information on a shape is not necessarily present, use of the intensity distribution enables detection of the feature information on any shape, for example, and setting of the inspection sensitivities therefor. In addition, in this embodiment, the description has been mainly given of the case where the intensity distribution is used, but distribution of colors (color phases) or chromas (saturations) can be used to detect the feature information and set the inspection sensitivities. A method using colors is effective when being applied to a general-purpose inspection and the like of a product other than a semiconductor manufacturing device.

### (10) Embodiment 10

Next, a description is given of a circuit pattern inspection device according to Embodiment 10. Note that a basic device configuration of the circuit pattern inspection device according to Embodiment 10 and basic processing steps thereof are the same as those in Embodiment 1. Hereinafter, only a difference from Embodiment 1 will be described. The difference between Embodiment 10 and Embodiment 1 is the content of processing up to generation of an adjusted difference image from a detected image.

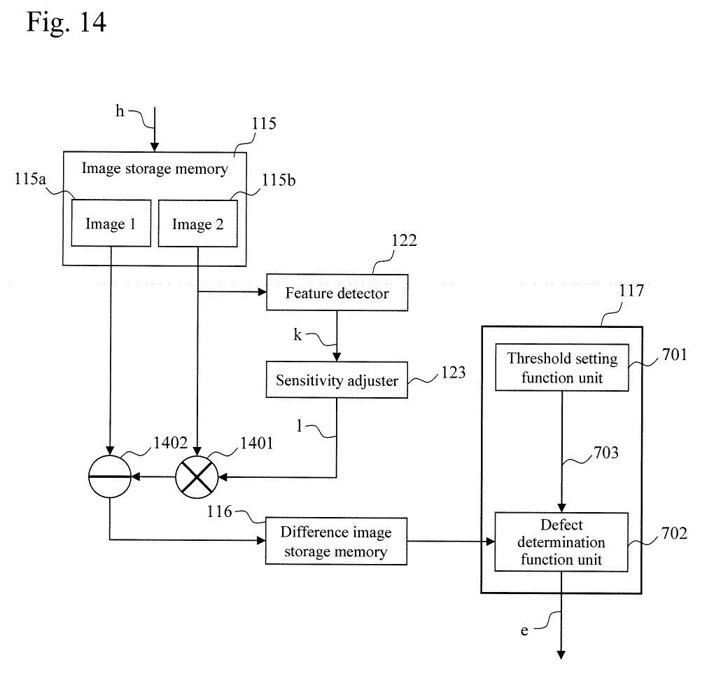

FIG. 14 shows processing steps employed in Embodiment 10. Note that portions in FIG. 14 corresponding to those in FIG. 7 are illustrated while being assigned the same reference signs.

Also in this embodiment, the feature detector 122 detects feature information from a detected image (115b), and the sensitivity adjuster 123 sets sensitivity coefficients g according to regions based on the detected feature information. However, in this embodiment, a sensitivity adjustment table l generated by the sensitivity adjuster 123 is applied to the detected image (115b). In other words, in this embodiment, the sensitivities of the detected image (115b) are adjusted by a sensitivity corrector 1401, before a difference image i is calculated. Thereby, only a DOI defect is extracted from the detected image (115b).

Thereafter, the detected image (115b) whose sensitivities are adjusted is given to a difference image generator 1402 to calculate a difference from a reference image (115a). Such processing steps also make it possible to obtain a difference image including only a DOI defect. In this embodiment, output from the difference image generator 1402 is stored in the difference image storage memory 116. Since processing operations after the operation of the defect determination unit 117 are the same as those in Embodiment 1, a description thereof will be omitted.

### (11) Embodiment 11

Next, a description is given of a circuit pattern inspection device according to Embodiment 11. Note that a basic device configuration of the circuit pattern inspection device according to Embodiment 11 and basic processing steps thereof are the same as those in Embodiment 1. Hereinafter, only a difference from Embodiment 1 will be described. The difference between Embodiment 11 and Embodiment 1 is an application target of a sensitivity adjustment table l. In Embodiment 1, the description has been given of the case where the sensitivity adjustment table l is given to the sensitivity corrector 125. Meanwhile, in Embodiment 10 described above, the description has been given of the case where the sensitivity adjustment table l is given to the sensitivity corrector 1401. However, in Embodiment 11, the sensitivity adjustment table l is used for correcting thresholds used by the defect determination unit 117.

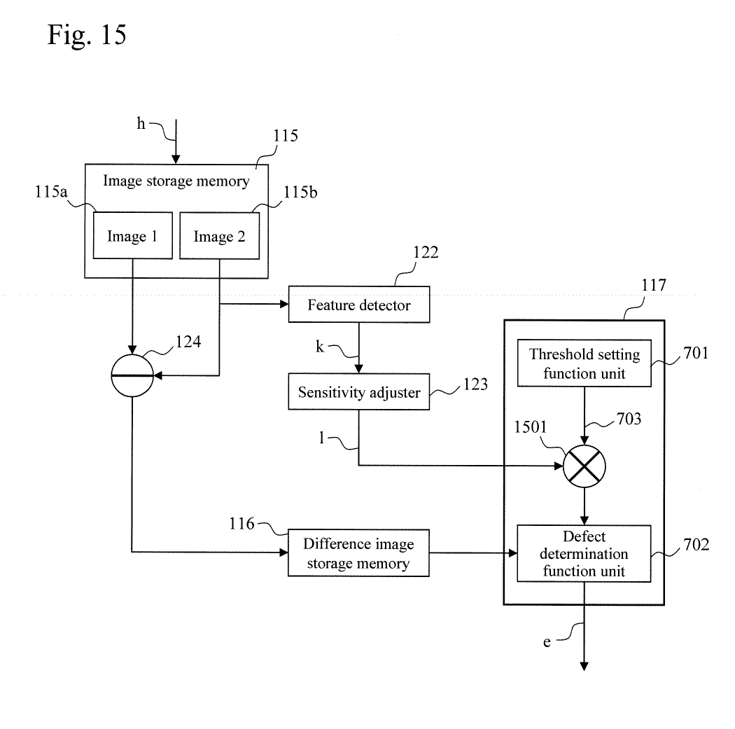

FIG. 15 shows processing steps employed in Embodiment 11. Note that portions of FIG. 15 corresponding to FIG. 7 are illustrated while being denoted by the same reference signs. Also in this embodiment, the feature detector 122 detects feature information from a detected image (115b), and the sensitivity adjuster 123 sets sensitivity coefficients g according to regions based on the detected feature information. Still also in this embodiment, the difference image generator 124 generates a difference image between a detected image (115b) and a reference image (115a) which are stored in the image storage memory 115.

However, in the embodiment, the difference image generated by the difference image generator 124 is stored in the difference image storage memory 116, and a sensitivity adjustment table l generated by the sensitivity adjuster 123 is given to a threshold corrector 1501 of the defect determination unit 117. The threshold corrector 1501 applies the sensitivity adjustment table l to the threshold table 703 given by the threshold setting function unit 701, and sets multiple thresholds in a single region of the detected image. For example, the threshold corrector 1501 sets a threshold of a region corresponding to a DOI defect to be low, and sets thresholds of the other regions to be high. Specifically, the defect determination function unit 702 determines a portion having an intensity larger than a threshold provided therefor as a defect, and determines a portion having an intensity smaller than a threshold provided therefor as not a defect. Thus, output from this defect determination function unit 702 is the same as the output from the defect determination function unit 702 in Embodiment 1.

### (12) Embodiment 12

Next, a description is given of a circuit pattern inspection device according to Embodiment 12. Note that a basic device configuration of the circuit pattern inspection device according to Embodiment 12 and basic processing steps thereof are the same as those in Embodiment 1. Hereinafter, only a difference from Embodiment 1 will be described.

In Embodiment 1 described above, the Hough transform has been used in the processing of detecting the feature information by the feature detector 122.

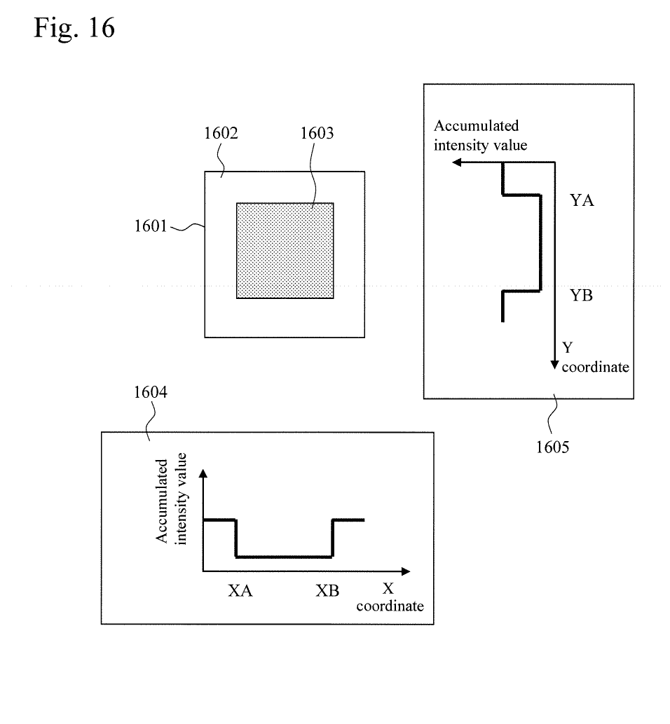

However, the feature information can be detected also by a method as shown in FIG. 16. FIG. 16 includes an inspected image 1601, a first accumulated intensity graph 1604, and a second accumulated intensity graph 1605. Note that the inspected image 1601 has a light region 1602 and a dark region 1603.

In this case, the feature detector 122 generates the first accumulated intensity graph 1604 in which intensity values of pixels having the same X coordinate are added in a Y coordinate direction. Next, the feature detector 122 generates the second accumulated intensity graph 1605 in which intensity values of pixels having the same Y coordinate are added in an X coordinate direction.

Since the inspected image 1601 has the light region 1602 and the dark region 1603, it is possible to find a region ranging from XA to XB having a low accumulated intensity value in the first accumulated intensity graph 1604. Similarly, it is possible to find a region ranging from YA to YB having a low accumulated intensity value in the second accumulated intensity graph 1605. Utilization of these results makes it possible for the feature detector 122 to detect a positional range of the dark region 1603 as a region surrounded by four points (XA, YA), (XB, YA), (XB, YB) and (XA, YB). It goes without saying that the light region 1602 can be detected as a region outside the dark region 1603.

In a case where the shape of a feature region is comparatively simple, such a method is applied thereto, and thereby the feature region can be detected by using a comparatively small amount of calculation.

### (13) Other Embodiment

In the aforementioned embodiments, the descriptions have been mainly given of the cases where a thin film device such as a wafer, a thin film transistor (TFT), or a photo mask is inspected. However, the technique according to the invention is not necessarily limited to an electron beam inspection device, but applicable to an appearance inspection device using lamp light, laser light or the like. In addition, as long as a device is intended for an inspection for a defect on the basis of a comparison between patterns which should to be originally identical with each other, the invention is applicable to the device without limiting an inspection target.

### EXPLANATION OF THE REFERENCE NUMERALS

102 . . . electron beam, 105 . . . charge control electrode, 106 . . . wafer, 110 . . . secondary signal, 113 . . . detector, 114 . . . digital image generator, 115 . . . image storage memory, 116 . . . difference image storage memory, 117 . . . defect determination unit, 118 . . . overall controller, 119 . . . console, 120 . . . light microscope, 121 . . . standard sample piece, 122 . . . feature detector, 123 . . . sensitivity adjuster, 124 . . . difference image generator, 125 . . . sensitivity corrector, 201 . . . die, 202 . . . memory mat group, 203 . . . memory mat, 204 . . . memory cell, 401 . . . map display portion, 402 . . . image display portion, 403 . . . defect information display portion, 404 . . . sensitivity setting button, 405 . . . comparison start button, 406 . . . tool bar for defect display threshold adjustment, 407 . . . defect, 408, 409, 410 . . . display region, 501 . . . sensitivity adjustment display portion, 502 . . . image display portion, 503 . . . sensitivity adjuster, 504 . . . shape detection button, 505 . . . application button, 506 . . . cancellation button, 507 . . . review button, 601, 602, 603 . . . hole pattern, 604 . . . wiring pattern, 803 . . . edge image, 804 . . . feature table, 805 . . . detected image, 806 . . . edge image, 807 . . . sensitivity adjustment table, 901 . . . difference image, 902, 903 . . . enlarged image, 904, 905a, 905b . . . defect, 906 . . . circular region, 907 . . . region having high sensitivity value, 908 . . . region having low sensitivity value, 1001 . . . background feature analyzer, 1102 . . . background feature adding unit, 1201 . . . background feature adding unit, 1301 . . . statistic calculation button, 1302 . . . statistic amount display portion, 1303 . . . sensitivity setting portion, 1401 . . . sensitivity corrector, 1402 . . . difference image generator, 1501 . . . threshold corrector, e . . . defect information signal, g . . . sensitivity coefficient, h . . . detected image, i . . . difference image, j . . . adjusted difference image, k . . . feature information, l . . . sensitivity adjustment table, m . . . background feature table, ma . . . white background sensitivity adjustment table, mb . . . black background sensitivity adjustment table

1. A defect inspection device characterized by comprising:
an image acquisition unit that acquires a detected image from an inspection region;
a difference image generator that generates a difference image between the detected image and a reference image;
a defect determination unit that determines a defect based on the difference image;
a sensitivity adjuster that sets a plurality of sensitivity regions in the inspection region based on features of an image in the inspection region; and
a sensitivity corrector that applies set sensitivities for the sensitivity regions to the detected image, the difference image or a determination threshold for the defect determination unit.

2. The defect inspection device according to claim 1, characterized by further comprising a background feature analyzer that classifies patterns forming the difference image according to intensity levels and generates classification information for each intensity level.

3. The defect inspection device according to any one of claims 1 and 2, characterized in that the plurality of sensitivity regions are set through an on-screen input operation by an operator.

4. The defect inspection device according to any one of claims 1 to 3, characterized in that the features of the image are set through an on-screen input operation by an operator.

5. The defect inspection device according to any one of claims 1 to 3, characterized in that the features of the image are detected by performing image processing on images corresponding to the respective inspection regions.

6. The defect inspection device according to claim 5, characterized in that the features of the image are detected based on differences in intensity or color between the inspection regions.

7. A defect inspection method characterized by comprising:
a step of acquiring a detected image from an inspection region through an image acquisition unit;
a step of reading the detected image and a reference image from a memory region and generating a difference image between the detected image and the reference image;
a step of applying a determination threshold to the difference image and determining a defect;
a step of setting a plurality of sensitivity regions in the inspection region based on features of an image in the inspection region; and
a step of applying set sensitivities for the sensitivity regions to the detected image, the difference image or the determination threshold.

8. The defect inspection method according to claim 7, characterized by further comprising a step of classifying patterns forming the difference image according to intensity levels and generating classification information for each intensity level.

9. The defect inspection method according to any one of claims 7 and 8, characterized in that the plurality of sensitivity regions are set through an on-screen input operation by an operator.

10. The defect inspection method according to any one of claims 7 to 9, characterized in that the features of the image are set through an on-screen input operation by an operator.

11. The defect inspection method according to any one of claims 7 to 9, characterized in that the features of the image are detected by performing image processing on images corresponding to the respective inspection regions.

12. The defect inspection method according to claim 11, characterized in that the features of the image are detected based on differences in intensity or color between the inspection regions
